(19) United States
(12) Patent Application Publication
(10) Pub. No.: US 2004/0196380 A1
(43) Pub. Date: Oct. 7, 2004

(54) Image processing device, camera and image processing method

(75) Inventors: Yoshihisa Shimazu, Kyoto (JP); Keiichi Tsumura, Hyogo (JP); Takahiro Iwasawa, Kyoto (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/805,431

(22) Filed: Mar. 22, 2004

(30) Foreign Application Priority Data
Apr. 2, 2003 (JP) 2003-098831

(51) Int. Cl. H04N 5/228

(52) U.S. Cl. 348/222.1

(57) ABSTRACT

An image processing device for performing image processing for an image signal output from an image sensor and outputting the results, including: a common memory having line memories for storing an image by row; an image processing section for performing the image processing using the common memory; and a CPU for controlling the image processing section. The image processing section includes a plurality of processing circuits each performing predetermined processing as the image processing. At least two of the plurality of processing circuits perform processing using the same common memory.

### BACKGROUND OF THE INVENTION

The present invention relates to an image processing technology of processing a signal output from an image sensor.

In digital cameras that use a charge-coupled device (CCD), a complementary metal oxide semiconductor (CMOS) image pickup device or the like as the image sensor, such as digital still cameras, digital camera-equipped mobile phones and digital video cameras, an image processing device performs image processing for an image signal read from the image sensor and outputs the results to a display device. In this relation, reading of an image from the image sensor and outputting of the image signal to the display device are made every line of a frame. Accordingly, each function block of the image processing device should desirably perform its processing using a line memory that can store data by line. As prior art techniques using a line memory, known are zooming using a line memory (see Japanese Laid-Open Patent Publication No. 2001-197348, for example), and performing image compression using a line memory while performing image processing by block (see Japanese Laid-Open Patent Publication No. 5-252522, for example).

As described above, image processing should desirably be performed using a line memory. In consideration of this, the prior art techniques described above may be combined to enable all items of the image processing to be performed using line memories. As a result, an image processing device having a configuration as follows can be obtained.

FIG. 9 is a block diagram of an example of the image processing device obtainable from the prior art techniques. The image processing device of FIG. 9 includes a preprocessing circuit 922, a YC signal processing circuit 924, a zoom-out circuit 926, a post-filter 928, a JPEG processing circuit 934 and a vertical enlargement circuit 936. The image processing device also includes line-unit memories 961 to 966 for the respective processing circuits. Each of the processing circuits performs its processing on a line-to-line basis using the corresponding memory.

Each memory must be prepared to have a capacity large enough to allow the corresponding processing circuit to process even the largest-size image that can be handled by the image processing device.

In an image processing device, various processing items are performed in combination. Therefore, in some cases, all the processing circuits described above are not necessarily used in performing a combination of processing items. In such cases, if memories are respectively provided for all the processing circuits, there will be a memory left unused for processing.

In recent years, with the increase of the number of pixels of an image sensor, the number of pixels of one line has increased and thus the capacity required for a line memory has increased. Also, with the recent increase of the number of functions of an image processing device, the number of processing circuits requiring a line memory has increased. The resultant increase of the capacity of the line memory has become a cause for raising the cost of the image processing device. There is however a desire for reduction of the cost of the image processing device.

### SUMMARY OF THE INVENTION

An object of the present invention is providing an image processing device of which the memory capacity is minimized.

Specifically, the present invention is directed to an image processing device for performing image processing for an image signal output from an image sensor and outputting the results, including: a common memory having line memories for storing an image by row as a unit; an image processing section for performing the image processing using the common memory; and a CPU for controlling the image processing section, wherein the image processing section includes a plurality of processing circuits each performing predetermined processing as the image processing, and at least two of the plurality of processing circuits perform processing using the same common memory.

According to the invention described above, the capacity of the common memory can be minimized when one of two processing circuits is not used and/or when only a small memory capacity is necessary.

In the image processing device described above, preferably, the image processing section includes as the plurality of processing circuits: a preprocessing circuit for performing preprocessing for the image signal output from the image sensor; a luminance/color-difference signal processing circuit for converting the preprocessed signal to a luminance signal and a color-difference signal and outputting the converted signals; a zoom-out circuit for scaling down an image represented by the luminance signal and the color-difference signal and outputting the resultant image; and a compression circuit for performing compression coding of an image corresponding to the output of the zoom-out circuit and outputting the results as an output of the image processing section.

According to the invention described above, when no scaling-down is required, the zoom-out circuit does not have to use the common memory. When scaling-down is required, the image is scaled down and thus the capacity of the common memory required for the compression circuit can be reduced. In this way, by sharing the same common memory, the memory capacity can be minimized.

Preferably, the image processing section further includes as the plurality of processing circuits: a vertical enlargement circuit; and a post-filter for performing post-filtering for the output of the zoom-out circuit and outputting the results to the compression circuit or the vertical enlargement circuit, wherein the vertical enlargement circuit performs vertical enlargement of enlarging the post-filtered image in the vertical direction and outputs the results as the output of the image processing section.

Preferably, the image processing device described above further includes an output section for converting an output of the image processing section to a signal suitable for display or write into a recording medium, wherein the output section is configured to perform the processing using the common memory used by the image processing section.

In the image processing device described above, preferably, an area of the common memory is allocated to each of the plurality of processing circuits according to the need of processing by the processing circuit.

The camera of the present invention includes: the image processing device described above; an image sensor for outputting an image signal to the image processing device; and a recording device for writing an output of the image processing device into a recording medium.

In another aspect, the present invention is directed to an image processing method for performing image processing for an image signal output from an image sensor and outputting the results, including the steps of: storing an image in a common memory by row; and performing the image processing using the common memory, wherein the step of performing the image processing includes a plurality of processing steps of performing predetermined processing as the image processing, and at least two of the plurality of processing steps perform processing using the same common memory.

### BRIEF DESCRIPTION OF THE DRAWINGS

FIG. 1 is a block diagram of an example of a camera having an image processing device of an embodiment of the present invention.

FIG. 2 is a block diagram of an example of an image processing section in FIG. 1.

FIG. 3 is a flowchart showing an example of a flow of processing performed by the image processing device in FIG. 1.

FIG. 4 is a view illustrating a first example of a flow of data in the image processing device in FIG. 1.

FIG. 5 is a view illustrating a second example of a flow of data in the image processing device in FIG. 1.

FIG. 6 is a view illustrating a third example of a flow of data in the image processing device in FIG. 1.

FIG. 7 is a view illustrating a fourth example of a flow of data in the image processing device in FIG. 1.

FIG. 8 is a view illustrating a fifth example of a flow of data in the image processing device in FIG. 1.

FIG. 9 is a block diagram of an example of an image processing device obtainable from conventional techniques.

### DESCRIPTION OF THE PREFERRED EMBODIMENTS

Hereinafter, a preferred embodiment of the present invention will be described with reference to the accompanying drawings.

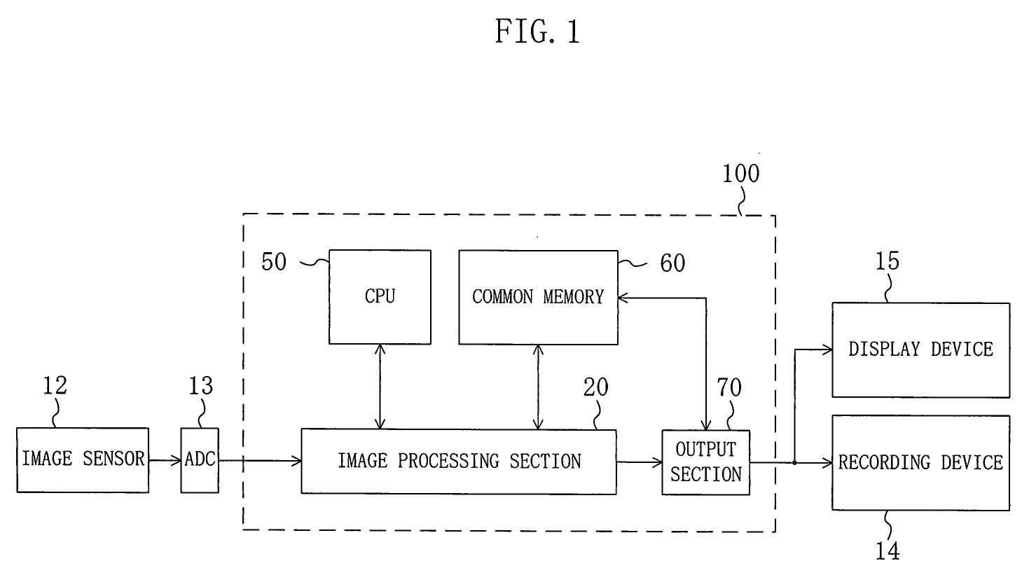

FIG. 1 is a block diagram of an example of a camera having an image processing device of an embodiment of the present invention. The camera of FIG. 1 is a digital still camera, a digital camera-equipped mobile phone or a digital video camera, for example. The camera of FIG. 1 includes an image processing device 100, an image sensor 12, an AD converter (ADC) 13, a recording device 14 and a display device 15. The image processing device 100 includes an image processing section 20, a CPU 50, a common memory 60 and an output section 70. Note that lines of pixels in the horizontal direction and those in the vertical direction are herein referred to as rows and columns, respectively.

The image sensor 12, which is a CCD or a CMOS image pickup device, for example, outputs an image signal to the AD converter 13. The AD converter 13 converts the input signal to digital data and outputs the resultant data to the image processing section 20.

The image processing section 20 performs image processing for the output of the image sensor 12 under instructions from the CPU 50 and outputs the results to the output section 70. In performing the image processing, the image processing section 20 uses the common memory 60.

The common memory 60 has a plurality of line memories for storing an image by row. Each line memory has a capacity permitting storage of data of m pixels (m is a natural number) (this capacity is referred to as 1H). Since pixels of one row of an image are not stored over a plurality of line memories, m is the maximum number of pixels allowed to be stored in the common memory 60 as one row of pixels. In general, therefore, m is the maximum number of pixels of one row of an image that can be processed by the image processing device 100. Assume herein that m=1280 and the common memory 60 has 18 line memories, for example.

The output section 70 has a buffer and operates as an interface that converts the output of the image processing section 20 to signals in forms suitable for write into a recording medium in the recording device 14 and for display with the display device 15 and outputs the resultant signals. The recording device 14 writes the output of the output section 70 into the recording medium such as a memory card. The display device 15, which is a liquid crystal display, for example, displays an image output from the image sensor 12 for monitoring.

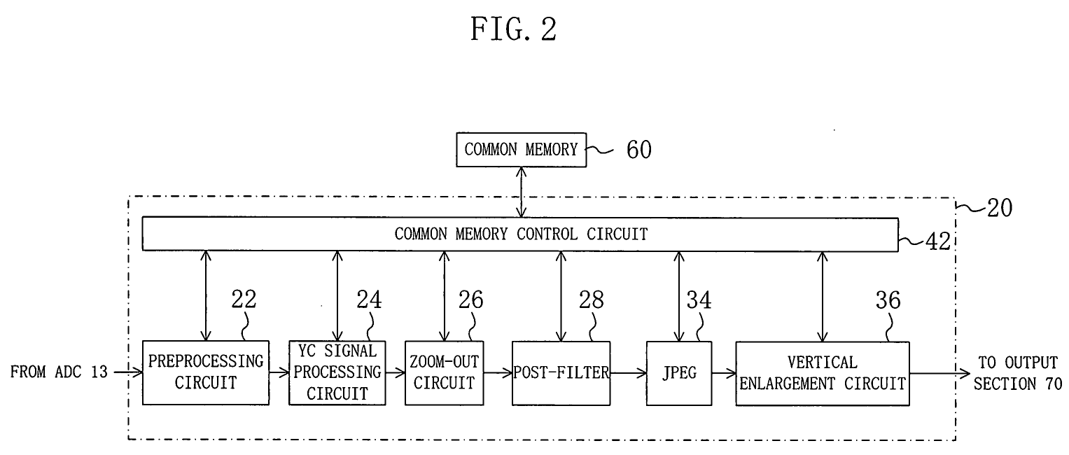

FIG. 2 is a block diagram of an example of the image processing section 20 in FIG. 1. The image processing section 20 includes a preprocessing circuit 22, a luminance/color-difference signal processing circuit (YC signal processing circuit) 24, a zoom-out circuit 26, a post-filter 28, a JPEG (joint photographic image coding experts group) processing circuit 34 and a vertical enlargement circuit 36. The image processing section 20 further includes a common memory control circuit 42. All of these circuits of the image processing section 20 operate under instructions from the CPU 50.

Assume that the preprocessing circuit 22, the YC signal processing circuit 24, the zoom-out circuit 26, the post-filter 28, the JPEG processing circuit 34 and the vertical enlargement circuit 36 are allowed to output received data as it is with no processing performed for the data. These circuits access the common memory 60 via the common memory control circuit 42.

The preprocessing circuit 22, the YC signal processing circuit 24, the zoom-out circuit 26, the post-filter 28, the JPEG processing circuit 34 and the vertical enlargement circuit 36 use the same memory in performing processing. To state differently, these processing circuits are configured to share the common memory 60. The CPU 50 allocates areas of the common memory 60 to these processing circuits according to the need of processing by the respective processing circuits.

The output section 70 also performs processing using the common memory 60 and is configured to share the common memory 60 together with the processing circuits of the image processing section 20. The CPU 50 allocates an area of the common memory 60 to the output section 70 according to the need of processing by the output section 70. Herein, however, description on the allocation of the common memory 60 to the output section 70 is omitted.

The preprocessing circuit 22 performs at least one of extraction of the black level, detection of the white balance and gamma correction as preprocessing for an image signal output from the image sensor 12, and outputs the results to the YC signal processing circuit 24.

The YC signal processing circuit 24 receives the output of the preprocessing circuit 22, performs YC signal processing for the received signal, and outputs the results to the zoom-out circuit 26. The YC signal processing includes correction of the black level, correction of the white balance and conversion to a luminance signal and a color-difference signal.

The zoom-out circuit 26 performs zooming using linear interpolation to scale down an image represented by the luminance signal and the color-difference signal, and outputs the results to the post-filter 28.

The post-filter 28, which has a variable-coefficient low-pass filter, performs post-filtering that includes allowing passing of a low-frequency component of the image received from the zoom-out circuit 26 and performing aperture correction, and outputs the results to the JPEG processing circuit 34.

The JPEG processing circuit 34 as a compression circuit performs JPEG-based compression coding (JPEG compression) for the image received from the post-filter, and outputs the results to the output section 70 via the vertical enlargement circuit 36. The JPEG compressed results are then sent to the recording device 14 to be written into a recording medium such as a memory card.

The vertical enlargement circuit 36 receives the image output from the post-filter 28 via the JPEG processing circuit 34, vertically enlarges the received image so that the number of pixels in the vertical direction matches the display device 15, and outputs the results to the output section 70. The vertically enlarged results are then sent to the display device 15 to be displayed.

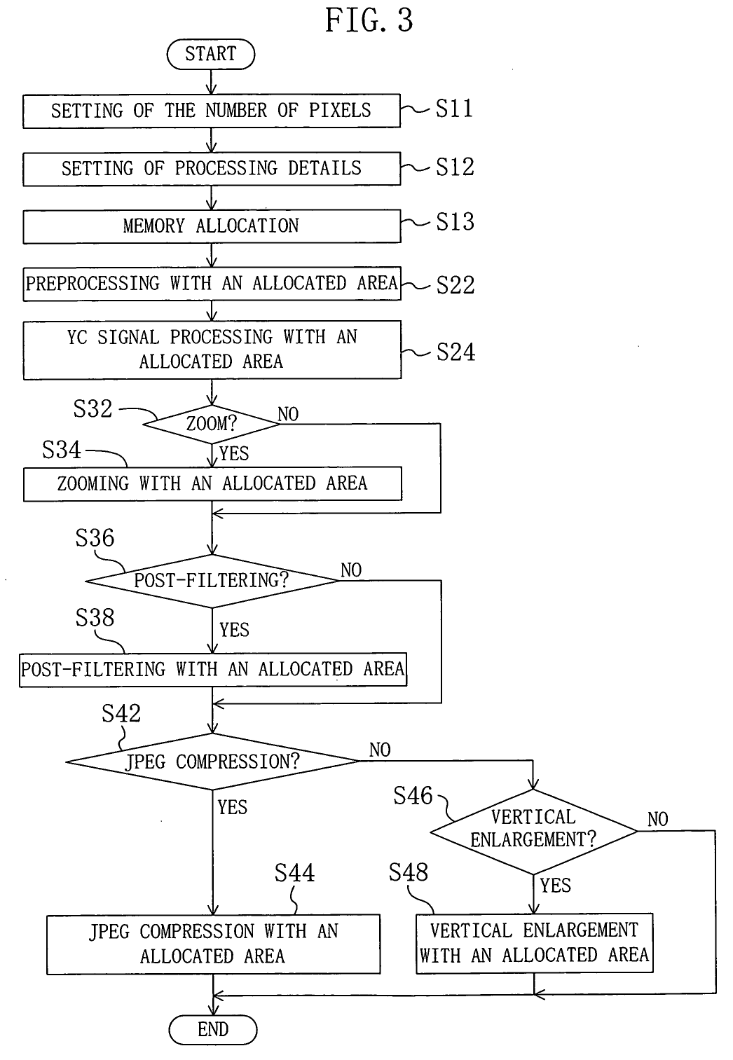

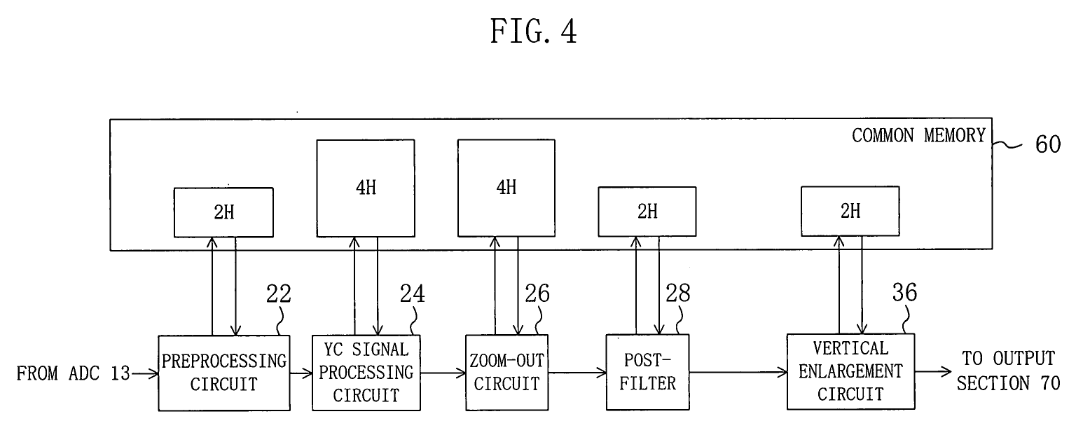

FIG. 3 is a flowchart showing an example of a flow of processing performed by the image processing device 100 in FIG. 1. FIG. 4 is a view illustrating a first example of a flow of data in the image processing device 100 in FIG. 1. Note that the common memory control circuit 42 is omitted in FIG. 4 and similar figures to follow illustrating a flow of data. In FIG. 4, assume that the size of an image output from the image sensor 12 is 1280 (=m) (horizontal)×960 pixels (vertical), and that preprocessing, YC signal processing, zooming (1/2× in this example), post-filtering and vertical enlargement are performed as the image processing. In this case, the data amount of one horizontal row of an image input into the image processing device 100 corresponds to 1H. The operation of the image processing device 100 in this example will be described with reference to FIGS. 2 to 4.

In step S11 in FIG. 3, the CPU 50 sets the horizontal number of pixels of an image represented by a signal output from the image sensor 12 as the horizontal number of pixels of an image input into the image processing device 100. This value can be set from outside the image processing device 100 based on the type of the image sensor 12 connected. More specifically, it is set whether or not the horizontal number of pixels of an image handled by the image processing device 100 is 1/2 or less of the number of pixels (=m) allowed to be stored in each line memory of the common memory 60.

If the horizontal number of pixels is m/2 or less, pixel data of two rows can be stored in one line memory. If the horizontal number of pixels is more than m/2, pixel data of only one row can be stored in one line memory. Therefore, depending on whether or not the horizontal number of pixels is m/2 or less, the capacities of areas of the common memory 60 allocated to the respective processing circuits must be changed. In the illustrated example, in which m=1280, it is set that the horizontal number of pixels is more than m/2.

In step S12, the CPU 50 sets processing details. Specifically, set are whether or not zooming, post-filtering, JPEG compression, vertical enlargement and the like are performed, together with the scaling factor of the zooming, if the zooming is performed, and the like. In the example of FIG. 4, it is set that zooming, post-filtering and vertical enlargement are performed and that the scaling factor of the zooming is 1/2.

In step S13, the CPU 50 allocates areas of the common memory 60 to the processing circuits of the image processing section 20, that is, the preprocessing circuit 22, the YC signal processing circuit 24, the zoom-out circuit 26, the post-filter 28, the JPEG processing circuit 34 and the vertical enlargement circuit 36.

The allocation of the common memory 60 is made for only the processing items to be actually performed. In the case of performing zooming with a scaling factor of 1/2 or less, for example, pixel data of a plurality of rows can be stored in one line memory in the subsequent processing. The allocation is also made considering this point.

In the example of FIG. 4, in which the scaling factor of the zooming is 1/2, data of two rows of a scaled-down image can be stored in one line memory. In the subsequent post-filtering and vertical enlargement, therefore, a line memory corresponding to 2H is necessary for each processing item. In consideration of the above, it is decided that line memories corresponding to 2H, 4H, 4H, 2H and 2H of the common memory 60 are allocated to the preprocessing circuit 22, the YC signal processing circuit 24, the zoom-out circuit 26, the post-filter 28 and the vertical enlargement circuit 36, respectively.

In step S22, the preprocessing circuit 22 performs preprocessing while conducting read/write with the area of the common memory 60 allocated to this circuit, handling each horizontal row of an image represented by an image signal output from the image sensor 12 as one unit, and outputs the results to the YC signal processing circuit 24. The process then proceeds to step S24.

In step S24, the YC signal processing circuit 24 performs YC signal processing while conducting read/write with the area of the common memory 60 allocated to this circuit, and outputs the results to the zoom-out circuit 26. The process then proceeds to step S32.

In step S32, the CPU 50 determines whether or not zooming is performed. The process proceeds to step S34 if zooming is performed, and otherwise proceeds to step S36. In the example of FIG. 4, in which zooming is performed, the process proceeds to step S34.

In step S34, the zoom-out circuit 26 performs zooming of reducing the number of pixels of an image while conducting read/write with the area of the common memory 60 allocated to this circuit, and outputs the results to the post-filter 28. The process then proceeds to step S36. In the example of FIG. 4, the zoom-out circuit 26 scales down the image so that the horizontal number of pixels is reduced to 1/2.

In step S36, the CPU 50 determines whether or not post-filtering is performed. The process proceeds to step S38 if post-filtering is performed, and otherwise proceeds to step S42. In the example of FIG. 4, in which post-filtering is performed, the process proceeds to step S38.

In step S38, the post-filter 28 performs post-filtering while conducting read/write with the area of the common memory 60 allocated to the post-filter, and outputs the results to the vertical enlargement circuit 36. The process then proceeds to step S42.

In step S42, the CPU 50 determines whether or not JPEG compression is performed. The process proceeds to step S44 if JPEG compression is performed, and otherwise proceeds to step S46. In the example of FIG. 4, in which JPEG compression is not performed, the process proceeds to step S46.

In step S46, the CPU 50 determines whether or not vertical enlargement is performed. The process proceeds to step S48 if vertical enlargement is performed, and otherwise the process is terminated.

In step S48, the vertical enlargement circuit 36 performs vertical enlargement while conducting read/write with the area of the common memory 60 allocated to this circuit, and outputs the results to the output section 70. The process is then terminated.

In step S44, the JPEG processing circuit 34 performs JPEG processing while conducting read/write with the area of the common memory 60 allocated to this circuit, and outputs the results to the output section 70 via the vertical enlargement circuit 36. The process is then terminated.

As described above, the image processing device 100 performs either the JPEG compression or the vertical enlargement. The common memory 60 is not required to have line memories for both the processing items. Therefore, the memory capacity can be reduced compared with the case of having independent memories for all the processing circuits.

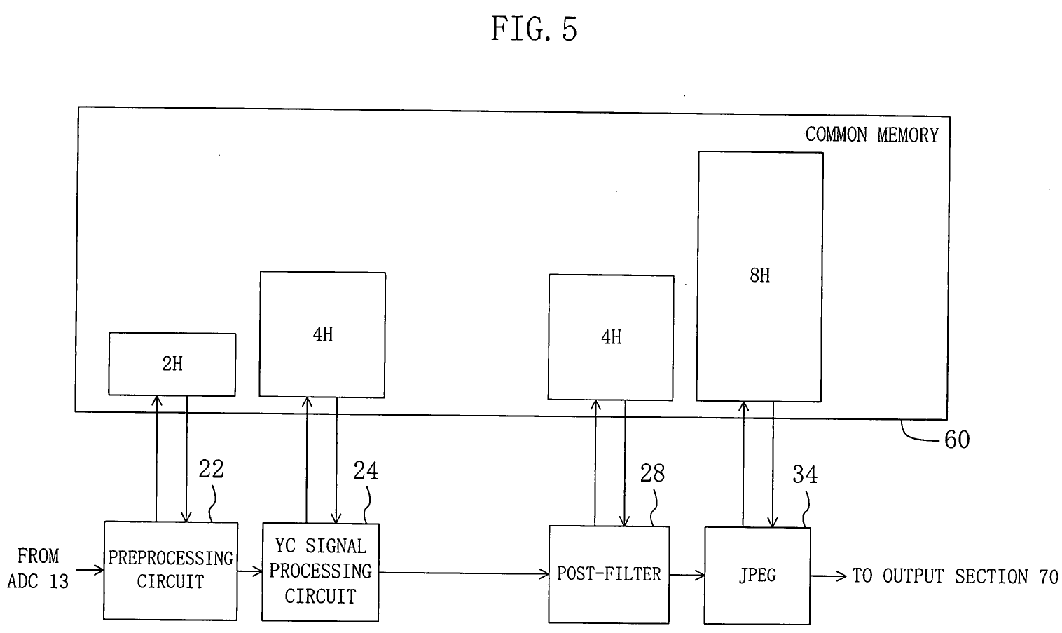

FIG. 5 is a view illustrating a second example of a flow of data in the image processing device 100 in FIG. 1. In the example of FIG. 5, as in the example of FIG. 4, assume that the size of an image output from the image sensor 12 is 1280 (=m) (horizontal)×960 pixels (vertical). In this example, assume that preprocessing, YC signal processing, post-filtering and JPEG compression are performed as the image processing. The operation of the image processing device 100 in this example will be described with reference to FIGS. 2, 3 and 5.

The processing in step S11 is substantially the same as that in the example of FIG. 4. In step S12, the CPU 50 sets post-filtering and JPEG compression as processing details.

In the example of FIG. 5, the horizontal number of pixels of an image input into the image processing device 100 is m and no zooming is performed. Accordingly, one line memory can store only data of one row of the image. In step S13, therefore, the CPU 50 allocates line memories corresponding to 2H, 4H, 4H and 8H of the common memory 60 to the preprocessing circuit 22, the YC signal processing circuit 24, the post-filter 28 and the JPEG processing circuit 34, respectively.

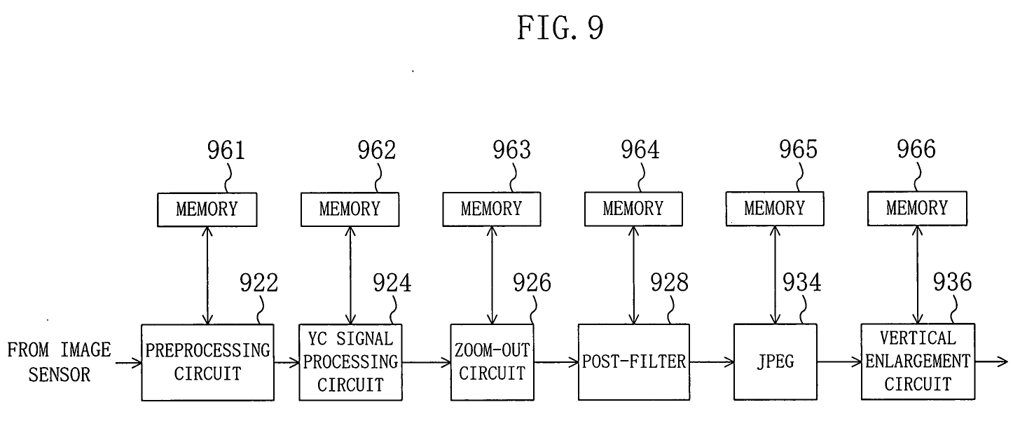

In the example of FIG. 5, the common memory 60 needs a capacity of a total of 18H. This is the case that the largest capacity is necessary for the common memory 60. However, in the case shown in FIG. 9 in which individual memories are provided for the respective processing circuits in place of a common memory, the capacity of 4H would invariably be necessary for each of memories for the zoom-out circuit and the vertical enlargement circuit. Compared with this case, therefore, the memory capacity of the image processing device can be reduced by 8H in this example.

The series of processing in and after step S22 are the same as those in the example of FIG. 4, except that the zooming in step S34 is not performed and that the JPEG processing in step S44 is performed in place of the vertical enlargement in step S48. Description of these steps is therefore omitted here.

As described above, in the image processing device 100 in this example, since no zooming is performed, no line memory is allocated to the zoom-out circuit 26. Therefore, with effective use of the limited space of the common memory 60, JPEG compression for the large-size image can be done without use of an external memory.

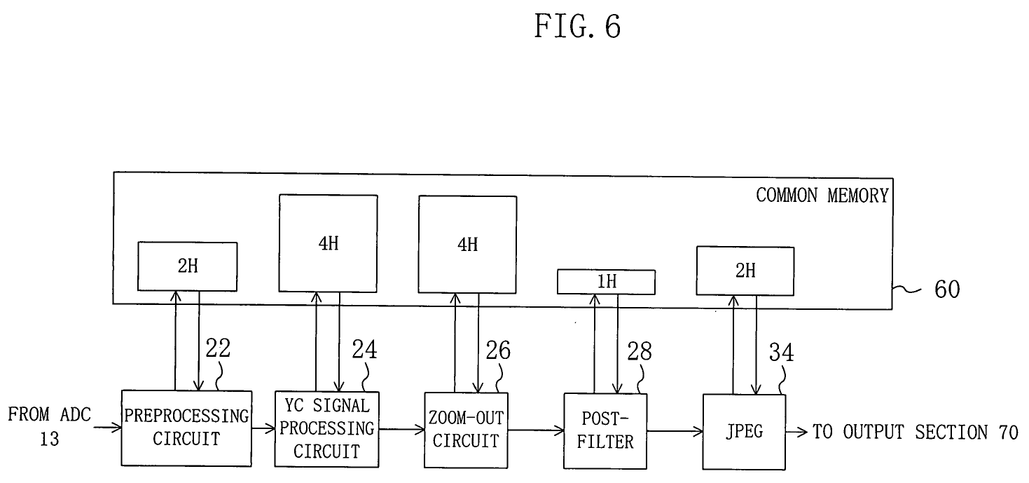

FIG. 6 is a view illustrating a third example of a flow of data in the image processing device 100 in FIG. 1. In the example of FIG. 6, as in the example of FIG. 4, assume that the size of an image output from the image sensor 12 is 1280 (=m) (horizontal)×960 pixels (vertical). In this example, assume that preprocessing, YC signal processing, zooming (1/4× in this example), post-filtering and JPEG compression are performed as the image processing. The operation of the image processing device 100 in this example will be described with reference to FIGS. 2, 3 and 6.

The processing in step S11 is substantially the same as that in the example of FIG. 4. In step S12, the CPU 50 sets that zooming, post-filtering and JPEG compression are performed and that the scaling factor of the zooming is 1/4.

In the example of FIG. 6, the horizontal number of pixels of an image input into the image processing device 100 is m and the scaling factor of the zooming is 1/4. Accordingly, data of four rows of a scaled-down image can be stored in one line memory.

In consideration of the above, line memories corresponding to 2H, 4H, 4H, 1H and 2H of the common memory 60 are allocated to the preprocessing circuit 22, the YC signal processing circuit 24, the zoom-out circuit 26, the post-filter 28 and the JPEG processing circuit 34, respectively.

The series of processing in and after step S22 are the same as those in the example of FIG. 4, except that JPEG processing in step S44 is performed in place of the vertical enlargement in step S48. Description of these steps is therefore omitted here.

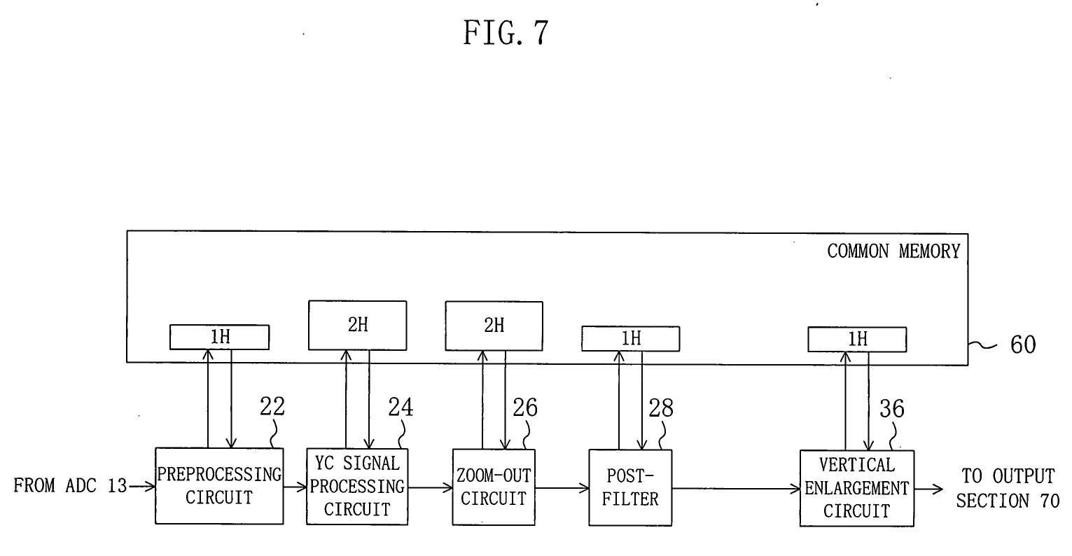

FIG. 7 is a view illustrating a fourth example of a flow of data in the image processing device 100 in FIG. 1. In the example of FIG. 7, assume that the size of an image output from the image sensor 12 is 640 (=m/2) (horizontal)×480 pixels (vertical), and that preprocessing, YC signal processing, zooming (1/2× in this example), post-filtering and vertical enlargement are performed as the image processing. In this case, the data amount of one horizontal row of an image input into the image processing device 100 corresponds to 1/2H. The operation of the image processing device 100 in this example will be described with reference to FIGS. 2, 3 and 7.

In step S11, the CPU 50 sets that the horizontal number of pixels of an image input into the image processing device 100 is m/2 or less. In step S12, the CPU 50 sets that zooming, post-filtering and vertical enlargement are performed and that the scaling factor of the zooming is 1/2.

In the example of FIG. 7, the horizontal number of pixels of an image input into the image processing device 100 is m/2 and the scaling factor of the zooming is 1/2. Accordingly, data of four rows of a scaled-down image can be stored in one line memory. In consideration of this, in step S13, the CPU 50 allocates line memories corresponding to 1H, 2H, 2H, 1H and 1H of the common memory 60 to the preprocessing circuit 22, the YC signal processing circuit 24, the zoom-out circuit 26, the post-filter 28 and the vertical enlargement circuit 36, respectively.

The series of processing in and after step S22 are the same as those in the example of FIG. 4. Description of these steps is therefore omitted here.

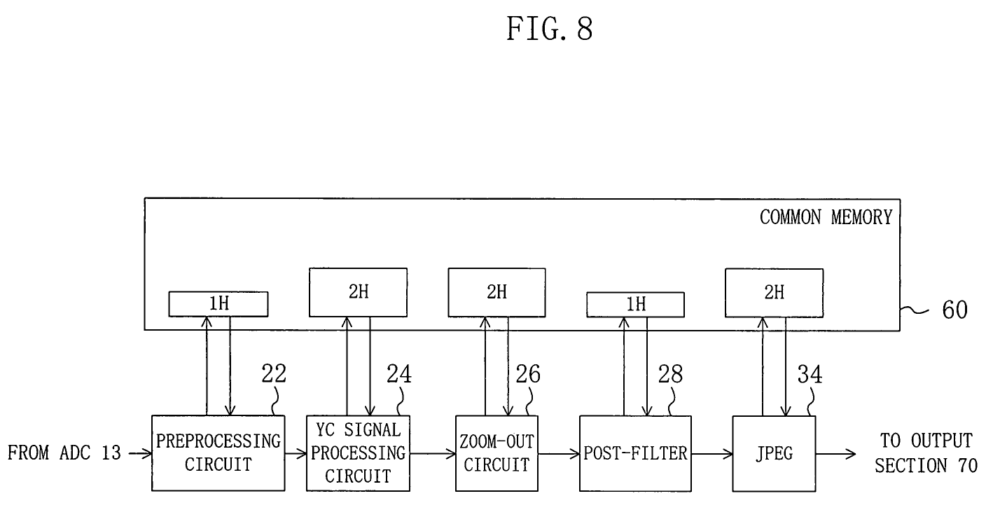

FIG. 8 is a view illustrating a fifth example of a flow of data in the image processing device 100 in FIG. 1. In the example of FIG. 8, assume that the size of an image output from the image sensor 12 is 640 (=m/2) (horizontal)×480 pixels (vertical), and that preprocessing, YC signal processing, zooming (1/2× in this example), post-filtering and JPEG compression are performed as the image processing. In this case, the data amount of one horizontal row of an image input into the image processing device 100 corresponds to 1/2H. The operation of the image processing device 100 in this example will be described with reference to FIGS. 2, 3 and 8.

The processing in step S11 is substantially the same as that in the example of FIG. 7. In step S12, the CPU 50 sets that zooming, post-filtering and JPEG compression are performed and that the scaling factor of the zooming is 1/2.

In the example of FIG. 8, the horizontal number of pixels of an image input into the image processing device 100 is m/2 and the scaling factor of the zooming is 1/2. Accordingly, data of four rows of a scaled-down image can be stored in one line memory. In consideration of this, in step S13, the CPU 50 allocates line memories corresponding to 1H, 2H, 2H, 1H and 2H of the common memory 60 to the preprocessing circuit 22, the YC signal processing circuit 24, the zoom-out circuit 26, the post-filter 28 and the JPEG processing circuit 34, respectively.

The series of processing in and after step S22 in FIG. 3 are the same as those in the example of FIG. 6. Description of these steps is therefore omitted here.

As described above, in the image processing device 100, the common memory is allocated to only a circuit that actually performs image processing by a capacity just required for the processing. This eliminates the necessity of preparing memories, each having the largest capacity to meet possible use by the corresponding processing circuit, for all the processing circuits of the image processing section.

In the embodiment described above, the image processing device includes one common memory. Alternatively, a plurality of common memories may be provided. For example, two circuits of the image processing section may share a first common memory, and other two circuits thereof may share a second common memory.

As described above, according to the present invention, the memory capacity required for an image processing device can be minimized. This enables cost reduction of the image processing device.

While the present invention has been described in a preferred embodiment, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. An image processing device for performing image processing for an image signal output from an image sensor and outputting the results, comprising:
a common memory having line memories for storing an image by row as a unit;
an image processing section for performing the image processing using the common memory; and
a CPU for controlling the image processing section,
wherein the image processing section includes a plurality of processing circuits each performing predetermined processing as the image processing, and
at least two of the plurality of processing circuits perform processing using the same common memory.

2. The device of claim 1, wherein the image processing section includes as the plurality of processing circuits:
a preprocessing circuit for performing preprocessing for the image signal output from the image sensor;
a luminance/color-difference signal processing circuit for converting the preprocessed signal to a luminance signal and a color-difference signal and outputting the converted signals;
a zoom-out circuit for scaling down an image represented by the luminance signal and the color-difference signal and outputting the resultant image; and
a compression circuit for performing compression coding of an image corresponding to the output of the zoom-out circuit and outputting the results as an output of the image processing section.

3. The device of claim 2, wherein the image processing section further includes as the plurality of processing circuits:
a vertical enlargement circuit; and
a post-filter for performing post-filtering for the output of the zoom-out circuit and outputting the results to the compression circuit or the vertical enlargement circuit,
wherein the vertical enlargement circuit performs vertical enlargement of enlarging the post-filtered image in the vertical direction and outputs the results as the output of the image processing section.

4. The device of claim 1, further comprising an output section for converting an output of the image processing section to a signal suitable for display or write into a recording medium,
wherein the output section is configured to perform the processing using the common memory used by the image processing section.

5. The device of claim 1, wherein an area of the common memory is allocated to each of the plurality of processing circuits according to the need of processing by the processing circuit.

6. A camera comprising:
the image processing device of claim 2;
an image sensor for outputting an image signal to the image processing device; and
a recording device for writing an output of the image processing device into a recording medium.

7. An image processing method for performing image processing for an image signal output from an image sensor and outputting the results, comprising the steps of:
storing an image in a common memory by row; and
performing the image processing using the common memory,
wherein the step of performing the image processing includes a plurality of processing steps of performing predetermined processing as the image processing, and
at least two of the plurality of processing steps perform processing using the same common memory.
